(19) United States
(12) Patent Application Publication
(10) Pub. No.: US 2007/0022450 A1
(43) Pub. Date: Jan. 25, 2007

(54) Image processing apparatus and control method thereof

(75) Inventors: Yun-sung Kim, Seoul (KR); Sang-hee Lee, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/404,832

(22) Filed: Apr. 17, 2006

(30) Foreign Application Priority Data
Jul. 21, 2005 (KR) 2005-0066466

(51) Int. Cl. G06F 3/00; H04N 7/173; G06F 13/00; H04N 5/445

(52) U.S. Cl. 725/86; 725/61; 725/87

(57) ABSTRACT

A control method of an image processing apparatus including a user input part and a display unit displaying an image according to a received broadcasting signal, includes determining whether broadcasting information is requested through operating the user input part; displaying a sub-channel image corresponding to at least one or more broadcasting channels in a portion of the display unit, when the broadcasting information is requested; and displaying channel information corresponding to the sub-channel image indicated by operating the user input part among at least one or more sub-channel images. Thus, an image processing apparatus and a control method thereof provide an electronic program guide (EPG) which is displayed on a portion of a screen of a display unit so that a user may easily browse broadcasting information on channels, when changing the channels.

### CROSS-REFERENCE TO RELATED APPLICATIONS

This application claims the benefit of Korean Patent Application No.: 10-2005-0066466, filed on Jul. 21, 2005, in the Korean Intellectual Property Office, the disclosure of which is incorporated herein by reference.

### BACKGROUND OF THE INVENTION

1. Field of the Invention

The present invention relates to a control method of an image processing apparatus, and more particularly, to an image processing apparatus and a control method thereof providing an electronic program guide (EPG) which is displayed on a portion of a screen of a display unit and by which a user may easily browse broadcasting information on channels, when changing the channels.

2. Description of the Related Art

An image processing apparatus comprises a signal processor processing a received broadcasting signal and a display unit displaying images according to the broadcasting signal processed in the signal processor.

Recently, as digital broadcast has become more available, the popularity of digital televisions which receixe and display a digital broadcasting signal has increased, and thus more people are able to view the digital broadcast. One characteristic of the digital broadcast is to provide a large amount of information on broadcasting channels and broadcasting programs.

Therefore, a conventional image processing apparatus (hereinafter, referred as a digital TV) receiving the digital broadcast and processing it receives EPG information containing a large amount of information on the broadcasting channels and the broadcasting programs, and displays an EPG screen according to the EPG information on the display unit to provide a user with the broadcasting information when the user requests it.

FIG. 1 is a drawing showing the EPG screen 1 which provides the broadcasting information in the conventional digital TV by the user's request, e.g., inputting the EPG information key. The conventional EPG screen 1 comprises broadcasting program information of each channel by time 1b, an image screen 1a of the broadcasting program instructed by the broadcasting program information of each channel by time 1b and specific information 1c on the instructed broadcasting program.

This conventional EPG screen 1 is displayed on the entire screen of the display unit, to provide broadcasting information to the user. However, if the EPG screen 1 is displayed on the entire screen of the display unit, the user cannot see a broadcasting screen which was originally seen. Also, if the user is unfamiliar with the digital broadcast, he may have trouble reverting back to the original broadcasting screen.

In order to solve these disadvantages, there is a digital TV displaying an EPG screen (not shown) which provides simple broadcasting information in a portion of a screen of the display unit. Additionally, the EPG screen may provide limited broadcasting information just on a current broadcasting channel, for example, when the size of a screen is smaller. Namely, the simple EPG screen provides only broadcasting program information by time on a broadcasting channel which is currently viewed, but does not provide information on another channel.

### SUMMARY OF THE INVENTION

Accordingly, it is an aspect of the present invention to provide an image processing apparatus and a control method thereof providing an electronic program guide (EPG) which is displayed on a portion of a screen of a display unit, so that a user may easily browse broadcasting information on channels, when changing the channels. Illustrative, non-limiting embodiments of the present invention overcome the above disadvantages and other disadvantages not described above. Also, the present invention is not required to overcome the disadvantages described above, and an illustrative, non-limiting embodiment of the present invention may not overcome any of the problems described above.

The foregoing and/or other aspects of the present invention are also achieved by providing a control method of an image processing apparatus comprising a user input part and a display unit displaying an image according to a received broadcasting signal, comprising: determining whether broadcasting information is requested through operating the user input part; displaying a sub-channel image corresponding to at least one or more broadcasting channels in a portion of the display unit, when the broadcasting information is requested; and displaying channel information corresponding to the sub-channel image indicated by operating the user input part among at least one or more sub-channel images.

According to an exemplary embodiment of the present invention, the control method of the image processing apparatus comprises displaying an electronic program guide comprising at least one or more sub-channel images and the channel information of the indicated sub-channel image in a portion of the display unit when the broadcasting information is requested.

According to an exemplary embodiment of the present invention, the indicating of the sub-channel image of the electronic program guide comprises disposing a highlighting part fixed on the electronic program guide, moving the sub-channel images to the left/right according to inputting a navigation left/right key of the user input part, and indicating one sub-channel image with the highlighting part according as the sub-channel images move.

According to an exemplary embodiment of the present invention, the sub-channel images corresponds to images of the same hourly programs as a program of the indicated sub-channel image among programs corresponding to at least one or more broadcasting channels.

According to an exemplary embodiment of the present invention, the displaying of the electronic program guide comprises arranging the indicated sub-channel image by the highlighting part and the sub-channel images on the electronic program guide in a circular shape and displaying the indicated sub-channel image more largely than the sub-channel images which are not indicated.

According to an exemplary embodiment of the present invention, the channel information comprises a channel number, a channel name and program information by time corresponding to the broadcasting channel of the indicated sub-channel image.

According to an exemplary embodiment of the present invention, the displaying of the electronic program guide further comprises arranging the program information by time corresponding to the broadcasting channel of the indicated sub-channel image in a certain direction; and displaying the sub-channel image corresponding to the program according to the time indicated by operating the user input part from the program information by time arranged in the certain direction, in the highlighting part.

According to an exemplary embodiment of the present invention, the indicating of the program information by time of the electronic program guide performs to move the highlighting part on the electronic program guide through inputting a navigation up/down key of the user input part.

According to an exemplary embodiment of the present invention, the displaying of the electronic program guide is performed to display the program information by time corresponding to the indicated sub-channel image in the vertical direction and up and down icons to move the program information by time displayed on the electronic program guide along the vertical direction in case that the number of programs to be displayed is more than the number of programs capable of being displayed and there are more programs before the program displayed in the top and after the program displayed in the bottom.

According to an exemplary embodiment of the present invention, the sub-channel image is a thumbnail image showing the program by time corresponding to each broadcasting channel.

According to an exemplary embodiment of the present invention, the displaying the electronic program guide, when the broadcasting signal corresponding to the sub-channel image indicated by the highlighting part is received, is performed to process an image signal of the broadcasting signal in a picture in picture method and display a motion picture processed in the PIP method as the sub-channel image in the highlighting part.

According to an exemplary embodiment of the present invention, the displaying the electronic program guide is performed to display the sub-channel images not indicated by the highlighting part in a half-tone method.

The foregoing and/or other aspects of the present invention are also achieved by providing an image processing apparatus comprising a user input part and a display unit for displaying an image according to a received broadcasting signal, comprising: a processor which processes the broadcasting signal to be displayed in the display unit; a UI generator which generates an electronic program guide comprising sub-channel images corresponding to at least one or more channels and channel information corresponding to an indicated sub-channel image of at least one or more sub-channel images; and a controller which controls the processor to display the received broadcasting signal and the UI generator to display the electronic program guide in a portion of the display unit when broadcasting information is requested through operating the user input part.

### BRIEF DESCRIPTION OF THE DRAWINGS

The above and/or other aspects and advantages of the present invention will become apparent and more readily appreciated from the following description of the exemplary embodiments, taken in conjunction with the accompanying drawings of which:

FIG. 1 is an illustrated view showing broadcasting information in a conventional image processing apparatus;

FIG. 2 is a control block diagram of an image processing apparatus according to the present invention;

FIG. 3 is a flow chart of the image processing apparatus according to the present invention;

FIG. 4 is a flow chart of a specific exemplary embodiment illustrating broadcasting programs by time in the image processing apparatus according to FIG. 3;

FIG. 5 is an illustrated view showing an EPG screen according to a desired exemplary embodiment of the present invention;

FIGS. 6A and 6B are illustrated views showing sub-channel images which are transferred as a broadcasting channel is changed in the EPG screen in FIG. 5;

FIGS. 7A and 7B are illustrated views indicating broadcasting program information by time in the EPG screen in FIG. 5; and

FIG. 8 is an illustrated view of an EPG screen according to another exemplary embodiment of the present invention.

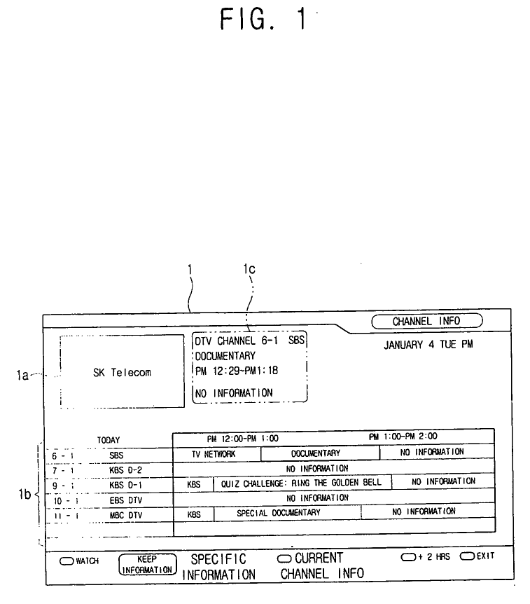

### DETAILED DESCRIPTION OF EXEMPLARY EMBODIMENTS

Aspects of the present invention will now be described in detail with reference to exemplary embodiments of the present invention, examples of which are illustrated in the accompanying drawings. The exemplary embodiments are described below in order to explain the present invention by referring to the figures, wherein like reference numerals refer to like elements throughout.

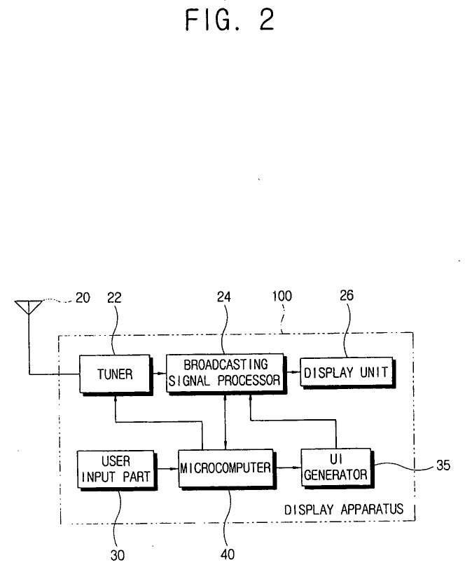

Referring to FIG. 2, an exemplary embodiment will be described with a display apparatus 100, receiving a digital broadcasting signal and processing it, as an example of an image processing apparatus as follows. An image processing apparatus 100 according to the present embodiment comprises an antenna 20, a tuner 22, a broadcasting signal processor 24, a display unit 26, a UI generator 35, a user input part 30 and a microcomputer 40.

The antenna 20 functions as a part receiving a broadcasting signal, i.e., receives a digital broadcasting signal.

The tuner 22 is inputted with the digital broadcasting signal received through the antenna 20 and selects the broadcasting signal of a broadcasting channel selected through the user input part 30 according to control by the microcomputer 40.

The broadcasting signal processor 24 processes the selected broadcasting signal outputted from the tuner 22 so as to be displayed on the display unit 26. The broadcasting signal processor 24, although not shown in drawings, may comprise a channel decoder, a TP decoder and a video decoder. The channel decoder demodulates an IF broadcasting signal of the digital broadcasting signal, selected in the tuner 22, into a predetermined transport stream and outputs it. The TP decoder demodulates program information and a predetermined image signal of a corresponding channel, which is selected by a user, from the predetermined transport stream outputted from the channel decoder and outputs it. The video decoder is inputted with the predetermined image signal outputted from the TP decoder, unzips it, restores it to an original image signal, and then outputs the original signal. Further, the broadcasting signal processor 24 processes an image signal and an EPG signal, so that an image screen according to the image signal and an EPG screen according to the EPG signal are overlapped to display on the display unit 26 at the same time, wherein the image signal is the broadcasting signal outputted from the tuner 22 which is processed so as to be replayed and the EPG signal is outputted from a UI generator 35.

Furthermore, the microcomputer 40 controls extraction of various additional data extracted from the transport stream outputted from the channel decoder, which are classified and stored. Data needed to be displayed on the screen among the additional data is processed through the UI generator 35 according to control by the microcomputer 40, and thus is displayed on the display unit 26 by the broadcasting signal processor 24. The additional data comprises EPG information containing information about channels, programs, etc.

The display unit 26 is inputted with the image signal from the broadcasting signal processor 24, thereby displaying the image screen. The display unit 26 comprises a display panel (not shown) displaying images thereon and a panel driving part (not shown) processing the image signal inputted from the broadcasting signal processor 24 and making images for display on the display panel.

The user input part 30 outputs a key signal to the microcomputer 40 according to the user's operation. The user input part 30 may comprise an EPG key to request broadcasting information, a navigation up/down/left/right key, an EXIT key and a key signal generator which generates a key signal corresponding to an operation of a key, although not shown in drawings.

The user input part 30 may be disposed in a front surface of the display apparatus 100, or may be an input unit which is additionally connected to the display apparatus 100, e.g., a mouse, a keyboard, or a wireless remote controller. Therefore, if the user operates a key, the key signal generator generates a key signal corresponding to the operation of the key and outputs it to the microcomputer 40. Accordingly, the microcomputer 40 controls the broadcasting signal processor 24, the UI generator 35 and the tuner 22 corresponding to the key signal inputted from the key signal generator.

The UI generator 35 generates the EPG signal of a broadcasting information guide according to control by the microcomputer 40 based on the EPG information of the additional data extracted from the broadcasting signal processor 24. Thus, the EPG signal outputted by the UI generator 35 is mixed with the image signal outputted from the broadcasting signal processor 24, thereby being displayed on the display unit 26.

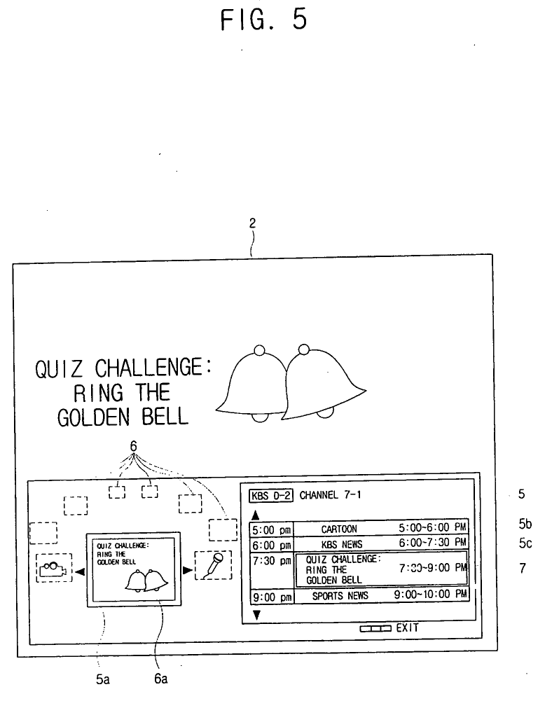

At this point, the UI generator 35 generates the EPG signal to display the EPG screen 5 in a portion of a screen currently being viewed 2, i.e., the entire screen of the display unit 26, as shown in FIG. 5. In FIG. 5, the EPG screen 5 will be described in detail as follows.

The EPG screen 5 comprises sub-channel images 6 and 6a of each different broadcasting channel, a fixed highlighting part 5a indicating one of the sub-channel images 6 and 6a and channel information 5b of the sub-channel image 6a indicated by the fixed highlighting part 5a.

The UI generator 35 displays the sub-channel images 6 and 6a arranged in a circular shape on the EPG screen 5. Preferably, but not necessarily, the sub-channel images 6 and 6a are displayed in an oval shape. Further, it is preferable that the sub-channel image 6a indicated by the fixed highlighting part 5a is larger than the sub-channel images 6 not indicated by the fixed highlighting part 5a in the size.

The sub-channel images 6 and 6a are preferably, but not necessarily, thumbnail images which show brief program information by time. The thumbnail images may be comprised in the EPG information extracted from the broadcasting signal processor 24 or image contents, i.e., entertainment, movie, sports, music, etc. established by the user. Also, the thumbnail image may be replaced with a logo image of a manufacturer of the display apparatus 100, e.g., SAMSUNG, if there is not any program on a certain channel at that time.

The UI generator 35 may display all the sub-channel images into the thumbnail images, or, as shown in FIG. 5, only the sub-channel image 6a indicated by the fixed highlighting part 5a and the sub-channel images right before and after the sub-channel image 6a into the thumbnail images.

Further, the UI generator 35 may display the sub-channel images 6 not indicated by the fixed highlighting part 5a in a half-tone method. In the half-tone method, the UI generator 35 tones the sub-channel images 6 down to the very low level, so that the sub-channel images 6 may not be seen.

The UI generator 35 displays the channel information 5b of the sub-channel image 6a indicated by the fixed highlighting part 5a on the EPG screen 5 according to control by the microcomputer 40 based on the EPG information. As shown in FIG. 5, the channel information 5b comprises a channel number (channel 7-1) and a channel name (KBS D-2) of the broadcasting channel corresponding to the sub-channel image 6a being indicated by the fixed highlighting part 5a and program information 5c of the broadcasting channel (channel 7-1) by time.

Preferably, but not necessarily, the UI generator 35 displays the program information 5c by time arranged vertically in a row. The UI generator 35 highlights the program information 5c, e.g., Quiz Challenge: Ring the Golden Bell, of the sub-channel image 6a at the corresponding time with a movable highlighting part 7.

The microcomputer 40 controls the UI generator 35 so as to display the EPG screen 5 in a portion of the display unit 26, if the EPG key of the user input part 30 is inputted to request the broadcasting information. It is preferable, but not necessary, that the microcomputer 40 controls the UI generator 35 so that the fixed highlighting part 5a indicates the sub-channel image of a current program provided by an established broadcasting channel (channel 11-1) or by a channel (channel 7-1) being currently viewed when the EPG key is inputted to start to display the EPG screen 5.

Although not shown in FIG. 2, the display apparatus 100 may further comprise an additional sub-antenna and a sub-tuner to receive a broadcasting signal, and the broadcasting signal processor 24 may comprise a picture in picture (PIP) processor for processing the broadcasting signal outputted from the sub-tuner in a PIP process. Accordingly, the microcomputer 40 can control the broadcasting signal processor 24 comprising the sub-tuner and the PIP processor based on the EPG information so as to select a broadcasting channel corresponding to the indicated sub-channel image and process the selected broadcasting signal in the PIP process, when the sub-channel image of the current program is displayed by the fixed highlighting part 5a. Further, motion pictures of the program processed in the PIP process by the broadcasting signal processor 24 may be displayed in the fixed highlighting part 5a as the sub-channel image.

When the navigation left/right key (e.g., [symbol] / [symbol] ) is inputted through the user input part 30, the microcomputer 40 controls the UI generator 35 to move the sub-channel images 6 and 6a to the left/right, so that a sub-channel image to be indicated by the fixed highlighting part 5a is changed, i.e., a broadcasting channel is changed to one corresponding to the sub-channel image indicated by the highlighting part 5a.

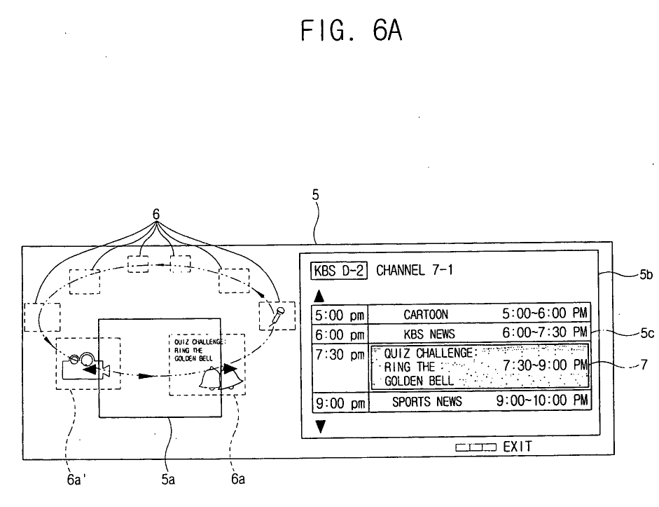

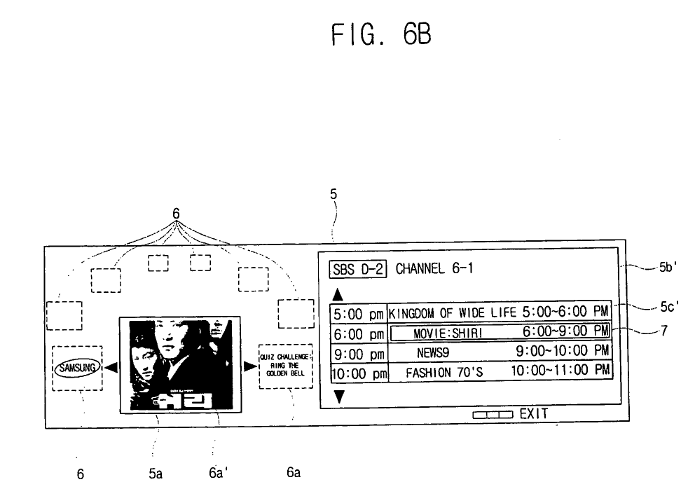

Referring to FIGS. 6A and 6B, it will be described how a sub-channel image indicated by the fixed highlighting part 5a is changed by operating the navigation left/right key through the user input part 30.

As shown in FIG. 5, if the navigation left key is inputted in the state that the EPG screen 5 is displayed, the. microcomputer 40 controls the UI generator 35 so as to move the sub-channel images 6 and 6a to the right. In that case, the sub-channel images 6 and 6a of the EPG screen 5 move to the right along the virtual cycle as shown in FIGS. 6A and 6B. Thus, the sub-channel image 6a′ which is displayed in the left side of the sub-channel image 6a indicated before the navigation left key is inputted gets indicated by the fixed highlighting part 5a, as shown in FIG. 6B.

As the sub-channel image indicated by the fixed highlighting part 5a is changed from 6a to 6a′, the broadcasting channel corresponding to the indicated sub-channel image is changed from channel 7-1 to channel 6-1, as shown in FIG. 6A and FIG. 6B, respectively. The microcomputer 40 controls the UI generator 35 based on the EPG information so as to display the channel information 5b′ of the broadcasting channel corresponding to the sub-channel image 6a′ indicated by the fixed highlighting part 5a on the EPG screen 5.

The UI generator 35 controls the movable highlighting part 7 to indicate the program information, e.g., Shiri, corresponding to the sub-channel image 6a′ indicated by the fixed highlighting part 5a among the program information 5c′ which is arranged vertically and by time, as shown in FIG. 6B.

When the navigation right key of the user input part 30 is inputted, the following process is the same as when the navigation left key is inputted except that the sub-channel images 6 and 6a moves to the left.

Thus, the display apparatus 100 displays the EPG screen 5 in a portion of the display unit 26 and adjusts the navigation left/right key of the user input part 30 so as to move the sub-channel images 6 and 6a on the EPG screen 5 to the left/right, thereby providing the user with sub-channel images of different broadcasting channels at the same hour and the broadcasting information of the broadcasting channels corresponding to the sub-channel images.

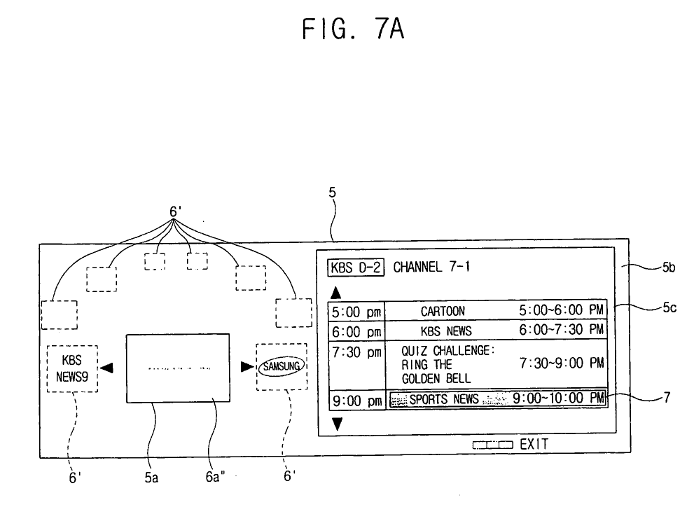

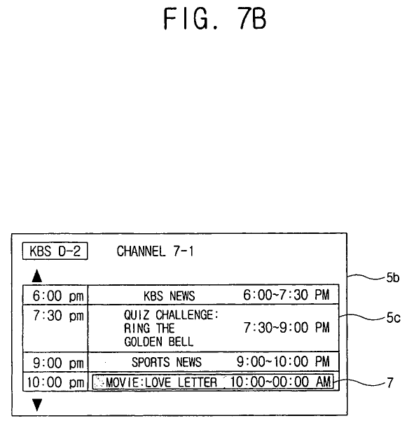

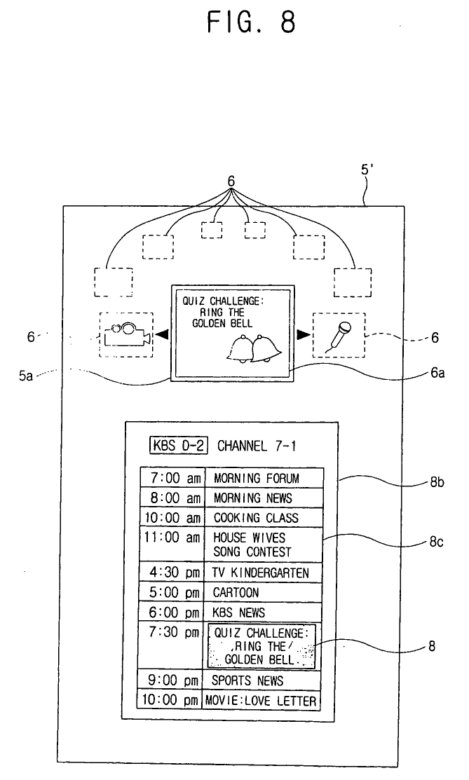

Referring to FIG. 7, it will be described how the highlighting part 7 moves by adjusting the navigation up/down key (e.g. ▴/▾) of the user input part 30 in the channel information 5b of the EPG screen 5 as follows.

When the navigation down key of the user input part 30 is inputted as the EPG screen 5 is being displayed, as shown in FIG.5, the microcomputer 40 controls the UI generator 35, so that the movable highlighting part 7 moves down to indicate program information, as shown in FIG. 7A. Accordingly, the highlighting part 7 indicates the following program, e.g., Sports News, below the program, e.g., Quiz Challenge: Ring the Golden Bell.

Likewise, as the highlighting part 7 moves from one program to the next one, i.e., from Quiz Challenge: Ring the Golden Bell to Sports News, the indicated broadcasting time is also changed from 7:30˜9:00 p.m. to 9:00˜10:00 p.m. As shown in FIG. 7A, the microcomputer 40 controls the UI generator 35 so as to display the sub-channel images 6′ and 6a″ of the respective channels at a certain time, i.e., 9:00˜10:00 p.m. corresponding to the program, i.e., Sports News, indicated by the movable highlighting part 7 on the EPG screen 5.

When the navigation up key of the user input part 30 is inputted, the following process is the same as one when the navigation down key is inputted except that the highlighting part 7 moves up to indicate the program information that corresponds to sub-channel images 6 and 6a.

Thus, the display apparatus 100 displays the EPG screen 5 in a portion of the display unit 26 and adjusts the navigation up/down key of the user input part 30 so as to move the sub-channel images 6 and 6a on the EPG screen 5 up/down, thereby providing the user with the broadcasting information on corresponding broadcasting channels by time and the sub-channel image of the indicated program.

If the number of programs to be displayed, e.g., 10 programs, is more than the number of programs capable of being displayed on the EPG screen 5 (e.g., 4 programs by time), the UI generator 35 displays up and down icons (▴ and ▾) to indicate that there are more programs before the program displayed in the top and after the program displayed in the bottom, as shown in FIG. 5.

Accordingly, when the navigation down key is inputted so that the movable highlighting part 7 indicates the program, e.g., Sports News, displayed in the bottom, the microcomputer 40 determines whether there is a subsequent program after the indicated program based on the EPG information. If there is a subsequent program after the indicated program, the microcomputer 40 controls the UI generator 35 so that the programs of the program information 5c move up by time slot. Next, the UI generator 35 displays program information, e.g., Movie: Love Letter, in the bottom which is not displayed before the navigation down key is inputted as shown in FIG. 7B, and controls the highlighting part 7 to indicate the program information. It is preferable, but not necessary, that the microcomputer 40 controls the UI generator 35 so as not to display the down icon based on the EPG information, if there is no program after the indicated program, i.e., Movie: Love Letter, as shown in FIG. 7B.

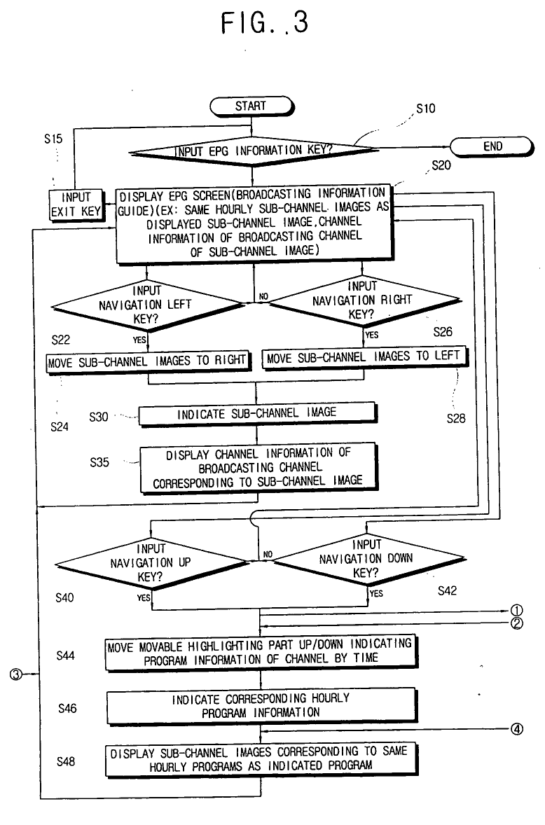

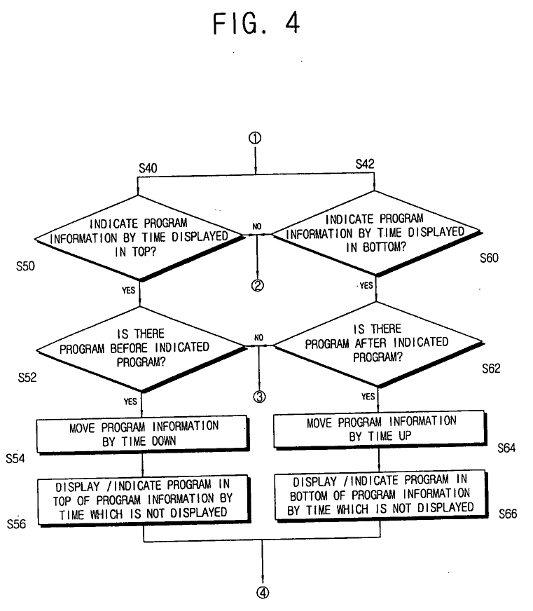

Hereinafter, referring to FIGS. 3 and 4, it will be described how the image processing apparatus is controlled according to the exemplary embodiment of the present invention. The control method of the image processing apparatus will be described with the display apparatus 100 based on FIG. 2.

First, the microcomputer 40 controls the tuner 22 and the broadcasting signal processor 24, thereby displaying a program selected by a user on the display unit 26. The microcomputer 40 determines whether the EPG information key of the user input part 30 is inputted, at operation S10. If the EPG information key is inputted, the microcomputer 40 controls the UI generator 35 so as to display the EPG screen 5 of the broadcasting information guide in a portion of the display unit 26, as shown in FIG. 5 and at operation S20. Preferably, but not necessarily, the EPG screen 5 displayed by the UI generator 35 has the same hourly sub-channel images 6 and 6a arranged in a circle thereon and comprises the channel information corresponding to the sub-channel image 6a indicated by the fixed highlighting part 5a. It is preferable, but not necessary, that the UI generator 35 displays the sub-channel image corresponding to a program which the user is watching with the fixed highlighting part 5a according to the control by the microcomputer 40 when the EPG screen 5 starts to be displayed. Therefore, when the EPG screen 5 is first displayed, the program displayed on an entire screen 2 of the display unit 26 may be the same as the indicated sub-channel image 6a.

Next, the microcomputer 40 determines whether the navigation left/right key of the user input part 30 is inputted, at operations S22 and S26. If the navigation right key is inputted, the microcomputer 40 controls the UI generator 35 so as to move the sub-channel images 6 and 6a to the left, at operation S28. Accordingly, the sub-channel images 6 and 6a on the EPG screen 5 moves to the left along a virtual circle, as shown in FIG. 6A. Then, the fixed highlighting part 5a indicates another sub-channel image, at operation S30. Further, if the navigation left key is inputted, the microcomputer 40 controls the UI generator 35 so as to move the sub-channel images 6 and 6a to the right, at operation S24. Accordingly, the sub-channel images 6 and 6a on the EPG screen 5 moves to the right along a virtual circle, as shown in FIG. 6A. Then, the fixed highlighting part 5a indicates the changed sub-channel image from 6a (in FIG. 5) to 6a′ (in FIG. 6B), at operation S30.

Therefore, if the sub-channel image indicated by the fixed highlighting part 5a is changed from 6a to 6a′, the UI generator 35 displays the channel information 5b′ corresponding to the sub-channel image 6a′ in FIG. 6B, at operation S35.

Accordingly, the sub-channel images 6 and 6a move to the left/right on the EPG screen 5 according to the input of the navigation left/right key of the user input part 30, so that the sub-channel image indicated by the fixed highlighting part 5a is changed, i.e., a channel corresponding to the sub-channel image indicated by the fixed highlighting part 5a is changed to another channel at the same hour. For example, the EPG screen 5 displays the changed channel information from 5b (in FIG. 5) to 5b′(in FIG. 6B) corresponding to a sub-channel image indicated by the highlighting part 5a.

Moreover, the microcomputer 40 determines whether the navigation up/down key is inputted, at operations S40 and S42. If the navigation up/down key is inputted, the microcomputer 40 controls the UI generator 35 so as to move the movable highlighting part 7 up/down to thereby indicate the program information 5c by time on the EPG screen 5, at operation S44. Accordingly, the movable highlighting part 7 indicates the corresponding program of the program information 5c by time on the EPG screen 5 according to the input of the navigation up/down key, at operation S46. For example, the navigation down key is inputted, as shown in FIG. 5, the microcomputer 40 controls the UI generator 35 so as to move the movable highlighting part 7 down, and thus to indicate the program as shown in FIG. 7A. When the navigation down key is inputted, the program Sports News is highlighted and displayed below the previous program Quiz Challenge: Ring the Golden Bell.

Thus, if the movable highlighting part 7 moves to indicate the program, from Quiz Challenge: Ring the Golden Bell to Sports News, the UI generator 35 displays the sub-channel images 6′ and 6″ of the respective channels in FIG. 7A corresponding to the same hourly programs as the changed program of Sports News, at operation S48.

Therefore, the control method of the image processing apparatus adjusts the navigation up/down key of the user input part 30 to move the movable highlighting part 7 up/down on the EPG screen 5, thereby providing the user with the broadcasting information on corresponding broadcasting channels by time and the sub-channel image of the indicated program.

Referring to FIG. 4, a process indicating the program of the program information 5c by time will be described in detail as follows.

When determining that the navigation up key is inputted as the EPG screen 5 is being displayed, at operation S40, the microcomputer 40 determines whether the current program indicated by the movable highlighting part 7 is displayed in the top of the program information 5c by time, at operation S50. If the movable highlighting part 7 does not indicate the program information displayed in the top, the operation follows at arrow 2, and then the operation S44 in FIG. 3 is performed. If the movable highlighting part 7 indicates the program information displayed in the top, the microcomputer 40 determines whether there is a program before the indicated program based on the EPG information, at operation S52. If there is not a program before the indicated program, the operation follows at arrow 3, and then the EPG screen 5 displays the indicated program without inputting the navigation up key. If there is a program before the indicated program, the microcomputer 40 controls the UI generator 35 to move the programs down by time, at operation S54. Accordingly, the UI generator 35 displays programs by time in the top of the program information 5c which are not displayed before the navigation up key is inputted so as to be indicated by the movable highlighting part 7, at operation S56, and then the operation follows at arrow 4.

On the other hand, when determining whether the navigation down key is inputted as the EPG screen 5 is being displayed at operation S42, the microcomputer 40 determines whether a current program indicated by the movable highlighting part 7 is displayed in the bottom of the program information 5c by time, at operation S60.

If the movable highlighting part 7 does not indicate the program information displayed in the bottom, the operation follows at arrow 2, and then the operation S44 in FIG. 3 is performed. If the movable highlighting part 7 indicates that the program information, i.e., Sports News, is displayed in the bottom, the microcomputer 40 determines whether there is a program after the indicated program, i.e., after 10:00 p.m. based on the EPG information, at operation S62. If there is not a program after the indicated program, the operation follows at arrow 3, and then the EPG screen 5 displays the indicated program without inputting the navigation, down key. However, if there is a program after the indicated program, the microcomputer 40 controls the UI generator 35 to move the programs by time up, at operation S64. Accordingly, the UI generator 35 displays a program, i.e., Love Letter, in the bottom of the program information 5c by time which is not displayed before the navigation down key is inputted so as to be indicated by the movable highlighting part 7, at operation S66, and then the operation follows at arrow 4.

At the operation S10, when an EXIT key is inputted at operation S15, the microcomputer 40 controls the UI generator 35 so as not to display the EPG screen 5.

In the drawings, the EPG screen 5 is displayed in the lower part of the display unit 26 in a horizontal direction. However, an EPG screen 5′, comprising sub-channel images 6 and 6a and channel information 8b arranged under the sub-channel images 6 and 6a in a lengthwise direction, may be, but not necessarily, displayed in the lengthwise direction in the left/right side of the display unit 26. Herein, the channel information 8b comprises program information by time 8c displaying all of ten programs by time. It is preferable, but not necessary, that the EPG screen 5′ does not comprise up and down icons (▴ and ▾) thereon to indicate that there are more programs before the program displayed in the top and after the program displayed in the bottom.

As previously discussed, the image processing apparatus and the control method thereof according to,the present invention provides the EPG screen 5 which is displayed on a portion of the screen of the display unit 26 while changing the channels, thereby not covering an entire screen of the display unit 26 and displays broadcasting information comprising sub-channel images and program information.

Accordingly, the user may easily obtain broadcasting information on other channels changed on the EPG screen 5 while watching one program.

Although a few exemplary embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A control method of an image processing apparatus comprising a user input part and a display unit which displays an image according to a received broadcasting signal, the control method comprising:
determining whether broadcasting information is requested through operating the user input part;
displaying a sub-channel image corresponding to one or more broadcasting channels in a portion of the display unit, when the broadcasting information is requested;
indicating one of the one or more sub-channel images as an indicated sub-image by operating the user input part; and
displaying channel information corresponding to the indicated sub-channel image among the one or more sub-channel images.

2. The control method of the image processing apparatus according to claim 1, further comprising: displaying an electronic program guide comprising the one or more sub-channel images, and the channel information of the indicated sub-channel image in a portion of the display unit if the broadcasting information is requested.

3. The control method of the image processing apparatus according to claim 2, wherein the indicating of the sub-channel image of the electronic program guide comprises: disposing a highlighting part fixed on the electronic program guide, moving the one or more sub-channel images to the left/right according to input of a navigation left/right key of the user input part, and indicating one sub-channel image with the highlighting part according as the sub-channel images move.

4. The control method of the image processing apparatus according to claim 3, wherein the sub-channel images correspond to images with programs at the same hour as a program of the indicated sub-channel image, among programs corresponding to at least one or more broadcasting channels.

5. The control method of the image processing apparatus according to claim 4, wherein the displaying of the electronic program guide comprises: arranging the indicated sub-channel image by the highlighting part and the one or more sub-channel images on the electronic program guide in a circular shape, and displaying the indicated sub-channel image more largely than the sub-channel images which is not indicated.

6. The control method of the image processing apparatus according to claim 5, wherein the channel information comprises: a channel number, a channel name, and program information by time corresponding to the broadcasting channel of the indicated sub-channel image.

7. The control method of the image processing apparatus according to claim 6, wherein the displaying of the electronic program guide further comprises: arranging the program information by time corresponding to the broadcasting channel of the indicated sub-channel image in a certain direction; and
displaying the indicated sub-channel image in the highlighting part which corresponds to the program according to the time indicated by operating the user input part from the program information arranged in the certain direction.

8. The control method of the image processing apparatus according to claim 7, wherein the indicating of the program information by time of the electronic program guide moves the highlighting part on the electronic program guide via a navigation up/down key of the user input part.

9. The control method of the image processing apparatus according to claim 8, wherein:
the displaying the electronic program guide is performed to display the program information by time in the vertical direction corresponding to the indicated sub-channel image, and
up and down icons are provided to move the program information by time, displayed on the electronic program guide, along the vertical direction when a number of programs to be displayed is more than a number of programs capable of being displayed and there are more programs preceding the program being displayed in the top and succeeding the program being displayed in the bottom.

10. The control method of the image processing apparatus according to claim 9, wherein the sub-channel image is a thumbnail image showing the program by time corresponding to each broadcasting channel.

11. The control method of the image processing apparatus according to claim 10, wherein if the broadcasting signal corresponding to the sub-channel image indicated by the highlighting part is received, the displaying of the electronic program guide is performed to process an image signal of the broadcasting signal in a picture in picture (PIP) method and to display a motion picture processed in the PIP method as the indicated sub-channel image in the highlighting part.

12. The control method of the image processing apparatus according to claim 11, wherein the displaying of the electronic program guide is performed to display the one or more sub-channel images, except the sub-channel image indicated by the highlighting part, in a half-tone method.

13. An image processing apparatus, comprising a user input part and a display unit which displays an image according to a received broadcasting signal, the image processing apparatus further comprising:
a processor which processes the broadcasting signal to be displayed in the display unit;
a UI generator which generates an electronic program guide comprising sub-channel images corresponding to one or more channels and channel information corresponding to an indicated sub-channel image of the one or more sub-channel images; and
a controller which controls the processor to display the received broadcasting signal and the UI generator to display the electronic program guide in a portion of the display unit if broadcasting information is requested through operating the user input part.
